(19) United States
(12) Patent Application Publication
(10) Pub. No.: US 2010/0325227 A1
(43) Pub. Date: Dec. 23, 2010

(54) Systems and methods for composite data message

(76) Inventor: Alon Novy, Palo Alto, CA (US)

Correspondence Address: Goodwin Procter LLP;Attn: Patent Administrator, 135 Commonwealth Drive, Menlo Park, CA, 94025-1105, US

(21) Appl. No.: 12/820,851

(22) Filed: Jun. 22, 2010

Related U.S. Application Data
(60) Provisional application No. 61/219,617, filed on Jun. 23, 2009.

(51) Int. Cl. G06F 15/16

(52) U.S. Cl. 709/206

(57) ABSTRACT

A new approach is proposed that contemplates systems and methods to communicate composite data messages using conventional messaging systems, particularly email systems, while preserving the integrity of the composite data messages without losing any information in the messages. More specifically, the structured data in a composite data message from a sender is serialized and converted into image data, where the resulting image data encodes the structured data. The converted image data is then attached to the free text portion of the composite data message as an embedded image to form a recomposed message. The recomposed message is then communicated to one or more recipients through a heterogeneous messaging environment comprising of one or more collaborating messaging systems. Upon receiving the second recomposed message, each recipient reconstructs the composite data message by converting the embedded image data into structured data.

### RELATED APPLICATIONS

This application claims the benefit of U.S. Provisional Patent Application No. 61/219,617, filed Jun. 23, 2009, and entitled “Systems and methods for composite data message,” by Alon Novy, and is fully incorporated herein by reference.

This application is related to U.S. Pat. No. 7,669,138, filed Oct. 27, 2006, and entitled “Interacting with a computer-based management system,” by Alon Novy, and is hereby incorporated herein by reference.

This application is related to U.S. patent application Ser. No. 11/457,873, filed Jul. 17, 2006, and entitled “Method and apparatus for providing structured data for free text messages,” by Alon Novy, and is hereby incorporated herein by reference.

### BACKGROUND

There exist many methods for electronically communicating messages from a first person (the “sender”) to one or more recipients. Such messages include but are not limited to, emails, instant messages, notices, Tweets, and other kinds of electronic messages exchangeable between the sender and the recipients. Typically, the data communicated in these messages comprise free text and optionally also comprise attached structured data (“attachments”), which include but are limited to one or more of, pictures, documents, calendar invitations, electronic business cards, XML files, and other forms of structured data.

Oftentimes, as messages are sent from sender to the recipients, the messages pass through a heterogeneous environment of collaborating messaging systems. For a non-limiting example, an email message may be sent by a sender from an email client application such as Microsoft Outlook running on a Microsoft Windows operating system to an email server such as Microsoft Exchange. The e-mail message may then be sent from Microsoft Exchange server to a variety of other forwarding email servers and be finally received by a recipient using a Thunderbird client application running on a Linux operating system. Further, it is typical that the direct recipient of the electronic message may optionally reply to the message and/or forward the message onto one or more other (indirect) recipients.

Typically, the sender has no a priori knowledge of the path taken by a given message en route to its recipient(s), and the sender often does not know what messaging software will be used by the direct recipients and/or the indirect recipients to whom the direct recipients may later forward to the message to. One consequence of this heterogeneous messaging environment is that the sender cannot rely on specific behavior of the various messaging systems that handle the electronic message to determine whether to include Attachments to the message or the format or content the attachments. For a non-limiting example, many e-mail servers implement anti-spam solutions that automatically detach or block attachments that appear to carry binary data of uncertain purpose.

Additionally, when a recipient of an electronic message responds to a received message with an attachment by, e.g., replying and/or forwarding, the handling of the Attachment in the response message is highly dependent on the particular messaging system used by the recipient to generate the response message, and is often also dependent on optional user-specific settings. For a non-limiting example, many messaging systems re-include the attachments from the original message when forwarding that message, but do not include the Attachments when generating a response message to the original message. Other messaging systems never include attachments when either forwarding or responding to the original message.

In many situations, instead of sending free-text only it is highly desirable to send a composite data message that comprises both free text and structured data as in the case of an activity messaging system disclosed in U.S. Pat. No. 7,669,138 and Patent Pub. No. 2007/0016614. The heterogeneous messaging environment discussed above, however, means that the sender cannot always expect the composite data message arriving unchanged at the direct or indirect recipient. In some cases, anti-spam software and firewalls may even block a composite data message altogether.

It is worth noting that some systems embed structured data in the free-text portion of a composite data message as text. For example, many helpdesk systems append an identifier (“Ticket Number”) into the subject of emails sent from the helpdesk system. The Ticket Number is typically used to group messages belonging to the same Ticket Number, and/or store related messages in the same folder/customer file. These solutions are unreliable not only because of differences in messaging systems behavior but also because recipients can easily intentionally and unintentionally modify this data and in so doing reduce or break the usability of the structured data. For example, modifying a ticket number in the subject of a message often means that the message will not be grouped with related messages and may even mean that the format of the ticket number can no longer be parsed by the helpdesk system, rendering the message useless to the helpdesk system.

Thus, there is an unsatisfied need for a means of sending a composite data message having structured data in a heterogeneous messaging environment that increases the probability that the message will be received by the recipients without losing the structured data.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

FIG. 1 depicts an example of a system diagram to support communication of composite data messages in a heterogeneous messaging environment.

FIG. 2 depicts a flowchart of an example of a process to support composite data message recomposition.

FIG. 3 depicts an example of implementation for generating image data from serialized structured data.

FIG. 4 depicts a flowchart of an example of a process to support composite data message reconstruction.

FIG. 5 depicts an example of implementation for converting image data into serialized data.

### DETAILED DESCRIPTION OF EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to communicate composite data messages using conventional messaging systems, particularly email systems, while preserving the integrity of the composite data messages without losing any information in the messages. Here, each composite data message comprises at least one of structured data and free text. More specifically, the structured data in a composite data message from a sender is serialized and converted into image data, where the resulting image data encodes the structured data. The converted image data is then attached to the free text portion of the composite data message as an embedded image to form a recomposed message. The recomposed message is then communicated to one or more recipients through a heterogeneous messaging environment comprising one or more collaborating messaging systems. Upon receiving the second recomposed message, each recipient reconstructs the composite data message by converting the embedded image data into structured data.

Since messaging systems commonly do not remove or block embedded images, and commonly reattach embedded images during both reply and forward operations, such an approach of converting and embedding structured data as image data reduces the risk that the integrity of the composite data message is compromised when the message is communicated, received and/or responded to.

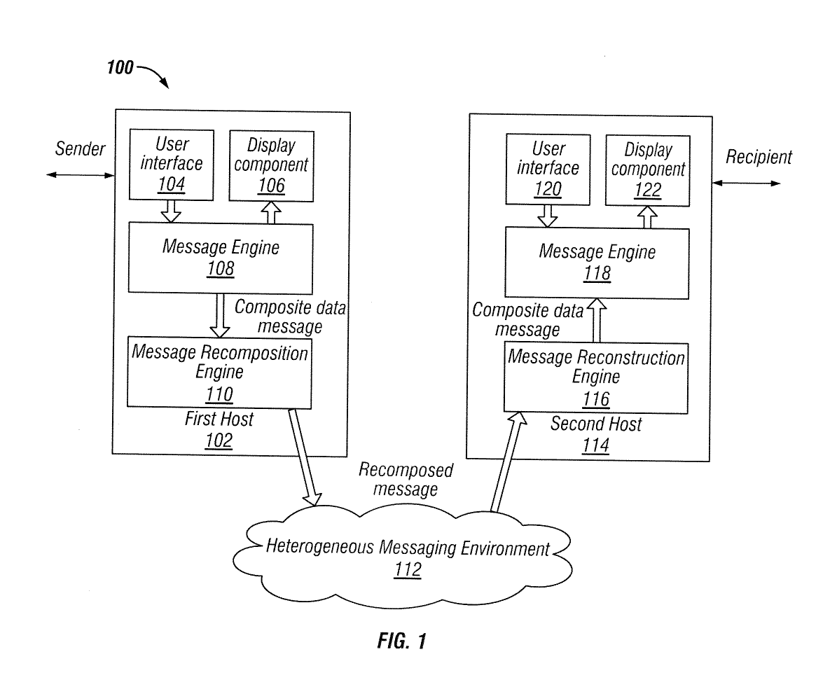

FIG. 1 depicts an example of a system diagram to support communication of composite data messages in a heterogeneous messaging environment. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes a first host (hosting device) 102 associated with a sender, wherein various engines and components running on host 102 include at least a user interface 104, a display component 106, a message engine 108, and a message recomposition engine 110; one or more second host 114 each associated with a recipient, wherein various engines and components running on host 114 include at least a message reconstruction engine 116, a message engine 118, a user interface 120, and a display component 122; and a heterogeneous messaging environment 112.

As used herein, the term “engine” or “component” refers to a software, firmware, hardware, or other component that is used to effectuate a purpose. The engine, component, or bridge will typically include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

In the example of FIG. 1, each of the first host 102 and the second host 114 can be a computing device, a communication device, a storage device, or any electronic device capable of running a software component. For non-limiting examples, a computing device can be but is not limited to, a laptop PC, a desktop PC, a tablet PC, an iPod, an iPad, a PDA, or a server machine. A storage device can be but is not limited to a hard disk drive, a flash memory drive, or any portable storage device. A communication device can be but is not limited to a mobile phone.

In the example of FIG. 1, each of the first host 102 and the second host 114 has a communication interface (not shown), which is a software component that enables the hosts to communicate with each other following certain communication protocols, such as TCP/IP protocol. The communication protocols between two devices are well known to those of skill in the art.

In some embodiments, the first host 102 and the second host 114 can be identical, wherein the sender and the recipient are associated with the same host to send and receive messages. Under such a scenario, the heterogeneous messaging environment 112 becomes optional as the messages are exchanged with the sender and the recipient without passing through via a network.

As used herein, each message can be but is not limited to one of email, instant message, notice, Tweet, and other kinds of electronic message exchangeable between the sender and the recipients. In some embodiments, the message can be a composite data message comprising both free-text and structured data, which include but are limited to, pictures, documents, calendar invitations, electronic business cards, XML files, and other forms of structured data. Generating and sending composite data messages decreases the probability that recipients of the messages intentionally or unintentionally reduce the integrity of the structured data.

In some embodiments, the composite data message is in accordance with a activity data schema compatible with a computer-based activity management system as discussed in U.S. Pat. No. 7,669,138 and U.S. patent application Ser. No. 11/457,873. For the activity management system, the free-text portion of the composite data message is for providing activity information to at least one human recipient about an action the sender would like the recipient to carry out, and the structured data portion of the message is for providing new information and/or updates to the same and/or other activity management system(s) about the work assignment according to the activity data schema.

In the example of FIG. 1, the user interface 104 and 120 running on the first host 102 and the second host 114, respectively, enables the sender and the recipients to interact with the message engines 108 and 118 in order to read, compose, reply to, or forward the messages or perform other message-related operations. Such user interface can be Web-based browser for web-based messaging systems.

In the example of FIG. 1, the display components 106 and 122 of the first host 102 and the second host 114, respectively, enables the sender and the recipients to review the messages being drafted or composed or read the messages received. Here, each of the display components 110 and 122 can be a monitor, a screen, or any other displaying device associated with the hosts 102 and 114 known to one skilled in the art including the entire displayable desktop of the hosts.

In the example of FIG. 1, the message engines 108 and 118 running on the first host 102 and the second host 114, respectively, enables the sender and the recipients to read, compose, reply to, or forward the messages or perform other message-related operations. In some embodiments, each message engine can be an email client application, which can be but is not limited to Microsoft Outlook running under a Microsoft Windows operating system, Mail running under Mac OS, or an email client under Linux operating system, wherein the email client application communicates with an email server such as Microsoft Exchange to send and receive messages to and from other email client applications. Alternatively, each message engine can be a Web-based email client, such as Yahoo Mail, Hotmail, Gmail, or AOL Mail, that are accessible via a Web browser, wherein such Web-based email client communicates to Web-based email servers over a network.

In the example of FIG. 1, the optional heterogeneous messaging environment 112 accepts and forwards messages exchanged between the sender and each of the recipients. Here, the messaging environment 112 may collaborate among a plurality of heterogeneous types of messaging systems, including but not limited to various kinds of client-server based email systems, Web-based email systems, or other electronic messaging systems such as social networks or Twitter systems. Under such heterogeneous messaging environment, messages from the sender can be received by an email server of the same messaging system as used by the sender and be forwarded to an email or forwarding server of another type of messaging system of one of the recipients, which may eventually deliver the messages to the recipient directly or indirectly.

In the example of FIG. 1, the first host 102, the second host 114, and the heterogeneous messaging environment 112 communicate and interact with each other via a network (not shown). Here, the network can be a communication network based on certain communication protocols, such as TCP/IP protocol. Such network can be but is not limited to, internet, intranet, wide area network (WAN), local area network (LAN), wireless network, Bluetooth, WiFi, and mobile communication network. The physical connections of the network and the communication protocols are well known to those of skill in the art.

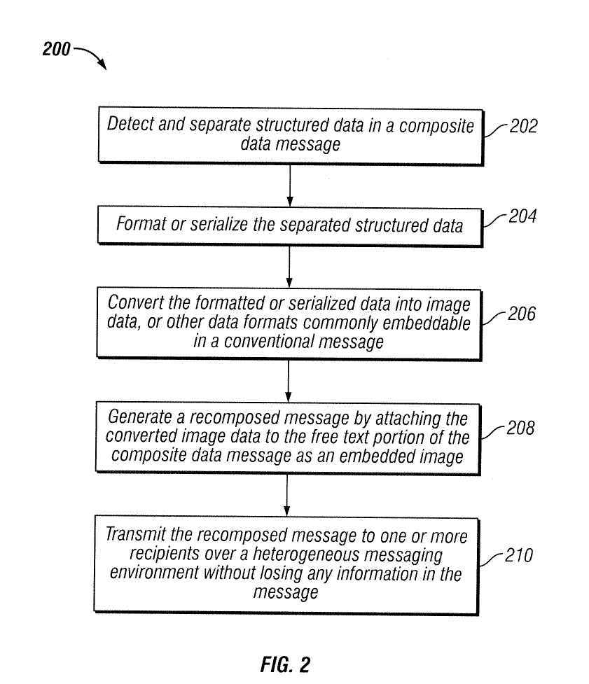

In the example of FIG. 1, message recomposition engine 110 running on the first host 102 accepts the composite data messages and converts them into recomposed messages suitable for communication in the heterogeneous messaging environment 112 without losing any information in the messages. FIG. 2 depicts a flowchart of an example of a process to support composite data message recomposition by message recomposition engine 110. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 2, the flowchart 200 starts at block 202 where message recomposition engine 110 detects structured data, if any, in a composite data message generated by message engine 108. If any such structured data exists, the message recomposition engine 110 then separates and detaches the structured data from the free text in the composite data message.

The flowchart 200 continues to block 204 where message recomposition engine 110 formats the separated structured data. In one embodiment the step of formatting the structured data comprises serializing the data. Here, data serialization by message recomposition engine 110 is a process of converting the structured data into a sequence of bits so that it can be stored or converted into a file of a different format, transmitted across a network. The series of bits received in the same or another host/messaging system can be utilized by message reconstruction engine 116 to create a semantically identical clone of the original structured data according to the serialization format.

In some embodiments, message recomposition engine 110 further compresses the serialized structured data while formatting the structured data so as to reduce the storage requirements for the data. The message recomposition engine 110 may utilize standard binary compressors, which can be but are limited to, MMR, JBIG, JBIG-2 and PWC, to compress the serialized structured data.

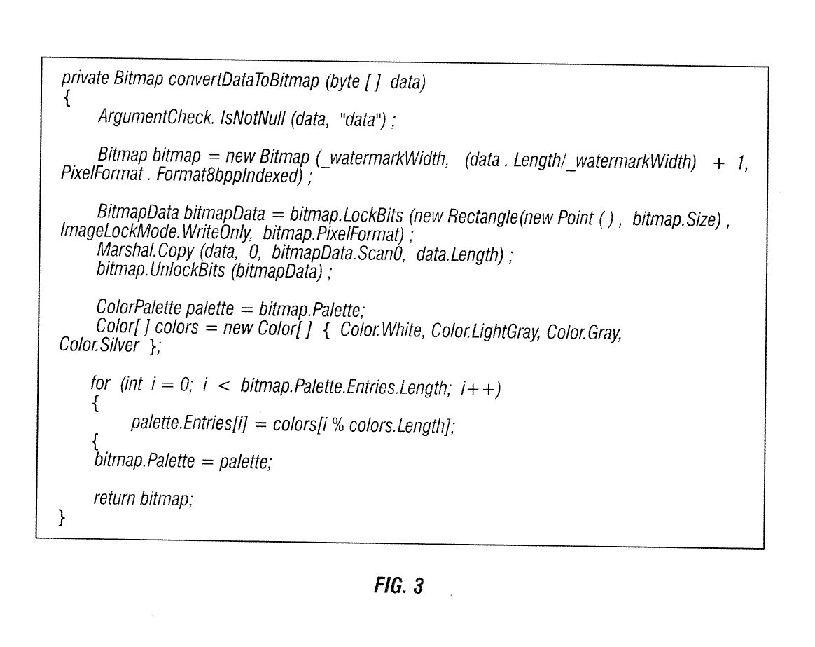

The flowchart 200 continues to block 206 where message recomposition engine 110 converts the formatted or serialized data into image data format, or other formats of data commonly embeddable in a conventional message. Here, various kinds of image data encoding schemes commonly supported by messaging systems can be adopted, including but not limited to JPG, PNG, etc. Under one scheme, the image data stores the color of each pixel in the image using one byte value per pixel. Under such image format, message recomposition engine 110 generates the image data via a process of determining the color of the first pixel by assigning the first byte of the data being converted into the image data, and assigning the color of the second pixel by assigning the second byte of the data being converted, and so on until each pixel is assigned the color of the corresponding byte of the data being converted until all bytes have been converted into the image data. FIG. 3 depicts an example of message recomposition engine 110 for generating image data from serialized structured data using C#.

In some embodiments, message recomposition engine 110 adopts alternate image encoding schemes, including but not limited to, schemes that do represent each pixel's color using a single byte, for a non-limiting example, schemes that using multiple bytes per pixel and schemes that use run-length encoding and other compression schemes. In other exemplary embodiments, the image data comprises separately pixel data and a palette that maps pixel data values to actual colors. Such embodiments optionally render image data invisible and/or more visually appealing.

In some embodiments, the image data generated by message recomposition engine 110 includes header information that identifies the image data as encoding the structured data of a specific composite data message. Additional embodiments further include at least one of data length, structured data schema, compression method and encryption method information in the header information. Such header information is useful in detecting and interpreting image data in received composite data messages.

In some embodiments, the header may optionally contain checksum (or similar) information that allows the recipient of the message, such as the message reconstruction engine 116 discussed later, to determine whether the structured data in the composite data message has retained its integrity and/or has not been tampered with during transmission over the heterogeneous messaging environment 112.

In some embodiments, message recomposition engine 110 provides some or all of such header information in the name assigned to the attached image data. According to yet another embodiment the header information is stored a central location, e.g., a web server or FTP server. In some embodiments, such header information may be stored on more than one central location, e.g., companies may wish to host private servers for backups of their employee's data in addition to the web or FTP server.

In some embodiments, message recomposition engine 110 provides/uploads and stores the converted image data to a central location, e.g., an Internet web or FTP server, and embeds a lookup reference, e.g., a hyperlink, in the recomposed message discussed next. Here, the lookup reference specifies where the image data is located and how to download the image data. Finally, in one embodiment, the lookup reference is itself converted into image data and embedded in the recomposed message.

The flowchart 200 continues to block 208 where message recomposition engine 110 generates a recomposed message by attaching the converted image data to the free text portion of the composite data message as an embedded image. Here, the attached image data is displayed as an embedded image as part of the message body together with the free text in the recomposed message. Consequently, the attached image data will not be lost when the recomposed message is transmitted through the plurality of heterogeneous messaging systems in the heterogeneous messaging environment 112. In some alternative embodiments, message recomposition engine 110 may choose to simply attach, but not embed, the image data in the recomposed message.

The flowchart 200 ends at block 210 where message recomposition engine 110 transmits the recomposed message to one or more recipients over heterogeneous messaging environment 112 without losing any information in the message. In some embodiments, message recomposition engine 110 may encrypt the recomposed message or the image data in the message before transmission with certain encryption methods and keys agreed upon with the message reconstruction engine 116 running on the second host 114 associated with the recipients to provide additional security for secured network communication over heterogeneous messaging environment 112. The message reconstruction engine 116 running on the second host 114 will then decrypt the encrypted message upon receipt following the same encryption methods and keys.

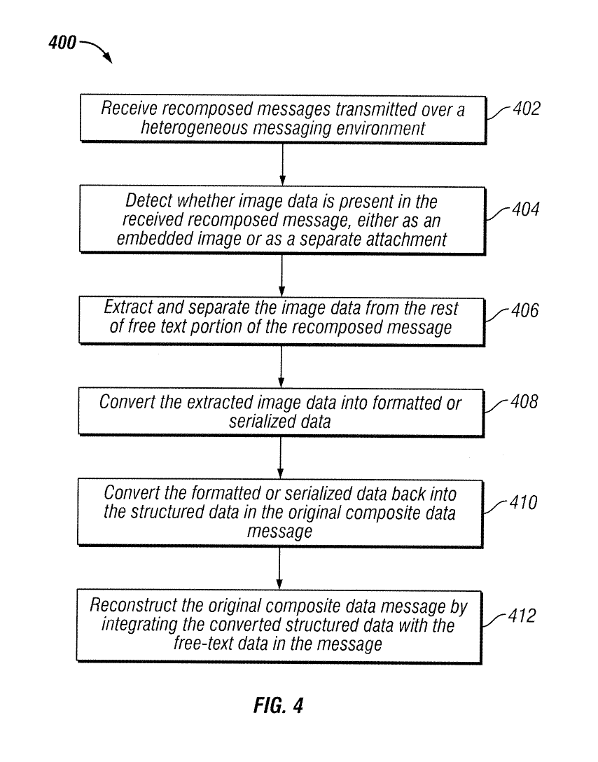

In the example of FIG. 1, message reconstruction engine 116 running on the second host 114 accepts the recomposed messages generated by the message recomposition engine 110 on first host 102 and reversely reconstructs them into the composite data messages originated by the sender without losing any information in the messages. FIG. 4 depicts a flowchart of an example of a process to support composite data message reconstruction by message reconstruction engine 116. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 4, the flowchart 400 starts at block 402 where message reconstruction engine 116 receives the recomposed messages transmitted over the heterogeneous messaging environment 112. The flowchart 400 continues to block 404 where message reconstruction engine 116 detects whether image data is present in the received recomposed message, either as an embedded image or as a separate attachment.

If the image data is detected in the message, the flowchart 400 continues to block 406 where message reconstruction engine 116 extracts and separates the image data from the rest of free text portion of the recomposed message. In some embodiments, if the image data is stored at a central location, message reconstruction engine 116 may optionally extracts and interprets a lookup reference embedded in the recomposed message, and then downloads the image data from the location specified by the lookup reference.

In some embodiments, message reconstruction engine 116 verifies the authenticity of the received message by comparing data in the received message against the data uploaded by the sender at the centralized location—particularly if the act of uploading the structured data requires the sender to provide user identification/authentication information.

In some embodiments, message reconstruction engine 116 extracts header from the image data of the received message in order to obtain and interpret information on encoding and/or encryption methods applied to the image data by the message recomposition engine 110. In some embodiments, message reconstruction engine 116 may further extract checksum (or similar) information from the header to determine whether the data has retained its integrity and/or has not been tampered with during transmission over the heterogeneous messaging environment 112.

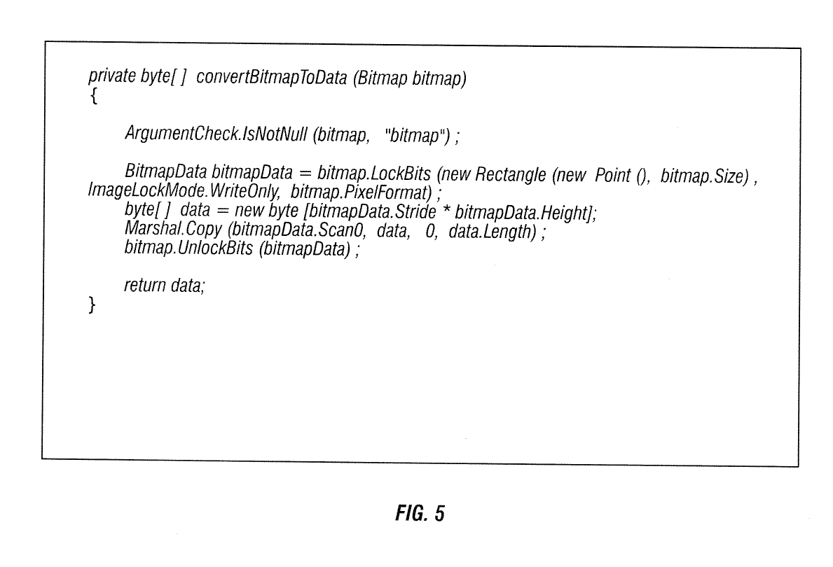

The flowchart 400 continues to block 408 where message reconstruction engine 116 converts the extracted image data into formatted or serialized data. Here, the message reconstruction engine 116 decrypts and decodes the image data following the same encryption key and encoding mechanisms adopted by message recomposition engine 110 to converting the image data back into the formatted or serialized data. FIG. 5 depicts an example of message reconstruction engine 116 for converting image data into serialized data using C#.

The flowchart 400 continues to block 410 where message reconstruction engine 116 converts the formatted or serialized data back into the structured data in the original composite data message. More specifically, message reconstruction engine 116 converts the series of bits in the serialized data into a semantically identical clone of the original structured data according to the same serialization format that is used by message recomposition engine 110 during formatting or serialization. If the serialized data is compressed, message reconstruction engine 116 will decompress it first via a decompressor corresponding to the compressor used by message recomposition engine 110 for compression. The flowchart 400 ends at block 412 where message reconstruction engine 116 reconstructs the original composite data message by integrating the converted structured data with the free-text data in the message.

Under certain circumstances, it is possible that the one or more of the steps in flowchart 400 described fail because, for a non-limiting example, the embedded image data has been lost or corrupted during transmission. When such failure happens, message reconstruction engine 116 infers at least some of the lost information based on other values that are part of the messages previously and/or subsequently received.

In some embodiments, where the message is tagged with an indicator that specifies the conversation to which the message belongs, message reconstruction engine 106 uses this indicator to infer a relationship between the received message and other previously and subsequently sent and received composite data messages that have been tagged as belonging to the same conversation. In addition, message reconstruction engine 106 may also utilize other useful information contained in the message, including but not limited to, information about the sender, the recipients, the subject, the priority, the creation date and time as well as the date time of sending and receipt.

In some embodiments, message reconstruction engine 106 may infer the structured data in the composite data message by conducting a semantic analysis on the contents of the received message to infer additional information. For non-limiting examples, such semantic analysis includes detecting keywords and phrases that indicate urgency. Those skilled in the art will appreciate that many such embodiments exist. In some embodiments, message reconstruction engine 106 may infer the lost data by providing a signal to the recipient indicative of the inferred data and accepting input from the recipient indicative of correction, acceptance or rejection of the inferred data.

While the system 100 depicted in FIG. 1 is in operation, the sender associated with first host 102 interacts with message engine 108 via user interface 104 and display component 106 to generate a composite data message that include both a free-text and a structured data. Message recomposition engine 110 running on the first host 102 accepts the composite data message and converts it into a recomposed message with the structured data portion of the composite data message converted into an attached or embedded image. The recomposed message is then communicated from first host 102 to second host 114 associated with one of the recipients through heterogeneous messaging environment 112 comprising of a plurality of collaborating messaging systems. The message reconstruction engine 116 running on the second host 114 accepts the recomposed message and reversely reconstructs the message into the identical composite data message originated by the sender without losing any information in the message by converting the attached/embedded image data into a semantically identical clone of the original structured data. The message engine 118 then presents the reconstructed composite data message to the recipient via display component 122 and enables the recipient to operate on it via user interface 120.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “interface” is used in the embodiments of the systems and methods described above, it will be evident that such concept can be interchangeably used with equivalent software concepts such as, class, method, type, module, component, bean, module, object model, process, thread, and other suitable concepts. While the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system, comprising:
a first host associated with a sender of a composite data message comprising at least a free text data and a structured data;
a message recomposition engine running on the first host, which in operation,
detects and separates the structured data from the composite data message;
converts the separated structured data into a data format commonly embeddable in a conventional message;
generates a recomposed message by attaching the converted data in the data format to the free text of the composite data message;
transmits the recomposed message to one or more recipients over a heterogeneous messaging environment without losing any information in the message.

2. The system of claim 1, further comprising:
a second host associated with a recipient of the recomposed message transmitted over the heterogeneous messaging environment;
a message reconstruction engine running on the second host, which in operation,
detects and extracts the attached or embedded data in the recomposed message from the rest of free text of the recomposed message;
reversely converts the extracted data back into the structured data in the original composite data message;
reconstructs the original composite data message by integrating the converted structured data with the free-text data in the message.

3. The system of claim 1, wherein:
the composite data message is one of: email, instant message, notice, Tweet, and other kinds of electronic message exchangeable between the sender and the recipients.

4. The system of claim 1, wherein:
the composite data message is in accordance with a activity data schema compatible with a computer-based activity management system.

5. The system of claim 1, wherein:
the structured data includes at least one of picture, document, calendar invitation, electronic business card, XML file, and other forms of structured data.

6. The system of claim 1, wherein:
the heterogeneous messaging environment comprises one or more collaborating messaging systems.

7. The system of claim 1, wherein:
each of the one or more collaborating messaging systems is one of a client-server based email system or a Web-based email system.

8. The system of claim 1, wherein:
the message recomposition engine further
formats or serializes the separated structured data;
converts the formatted or serialized data into the data format commonly embeddable in a conventional message.

9. The system of claim 8, wherein:
the message recomposition engine further compresses the formatted or serialized structured data so as to reduce the storage requirements for the data.

10. The system of claim 1, wherein:
the data format commonly embeddable in a conventional message is an image format and the converted data is image data.

11. The system of claim 10, wherein:
the image data includes header information that identifies the image data as encoding the structured data of the composite data message.

12. The system of claim 11, wherein:
the header contain information useful for detecting and interpreting image data in the composite data message.

13. The system of claim 11, wherein:
the header contains checksum information that allows a recipient of the message to determine whether the structured data in the composite data message has retained its integrity or has not been tampered with during transmission over the heterogeneous messaging environment.

14. The system of claim 11, wherein:
the message recomposition engine further
uploads and stores the image data and/or header at one or more central locations;
embeds a lookup reference in the recomposed message.

15. The system of claim 1, wherein:
the message recomposition engine further embeds and displays the attached image data as an embedded image together with the free text in the recomposed message.

16. The system of claim 1, wherein:
the message recomposition engine further encrypts the recomposed message or the attached data in the message before transmission.

17. The system of claim 2, wherein:
the message reconstruction engine further detects whether the attached data is present in the recomposed message either as an embedded data or as a separate attachment.

18. The system of claim 2, wherein:
the message reconstruction engine further
extracts and interprets a lookup reference embedded in the recomposed message;
downloads the attached or embedded data from the location specified by the lookup reference.

19. The system of claim 2, wherein:
the message reconstruction engine verifies authenticity of the received message by comparing data in the received message against the data uploaded by the sender at a centralized location.

20. The system of claim 2, wherein:
the message reconstruction engine extracts header from the image data of the received message in order to obtain and interpret information on encoding and/or encryption methods applied to the image data.

21. The system of claim 2, wherein:
the message reconstruction engine further
converts the extracted data into the formatted or serialized data;
converts the formatted or serialized data back into the structured data in the original composite data message.

22. The system of claim 2, wherein:
the message reconstruction engine infers at least some of information lost in transmission based on other values that are part of the messages previously and/or subsequently received.

23. The system of claim 22, wherein:
the message reconstruction engine infers a relationship between the received message and other previously and subsequently sent and received composite data messages that have been tagged as belonging to the same conversation via an indicator that specifies conversation to which the message belongs to.

24. The system of claim 22, wherein:
the message reconstruction engine infers the structured data in the composite data message by conducting a semantic analysis on contents of the received message to infer additional information.

25. The system of claim 22, wherein:
the message reconstruction engine infers lost data by providing a signal to the recipient indicative of the inferred data and accepting input from the recipient indicative of correction, acceptance or rejection of the inferred data.

26. A computer-implemented method, comprising:
detecting and separating structured data from a composite data message comprising at least a free text data and the structured data;
converting the separated structured data into a data format commonly embeddable in a conventional message;
generating a recomposed message by attaching the converted data in the data format to the free text of the composite data message;
transmitting the recomposed message to one or more recipients over a heterogeneous messaging environment without losing any information in the message.

27. The method of claim 26, further comprising:
detecting and extracting the attached or embedded data in the recomposed message from the rest of free text of the recomposed message;
reversely converting the extracted data back into the structured data in the original composite data message;
reconstructing the original composite data message by integrating the converted structured data with the free-text data in the message.

28. The method of claim 26, further comprising:
formatting or serializing the separated structured data;
converting the formatted or serialized data into the data format commonly embeddable in a conventional message.

29. The method of claim 28, further comprising:
compressing the formatted or serialized structured data so as to reduce the storage requirements for the data.

30. The method of claim 26, further comprising:
converting the separating structured data into an image data;
generating the recomposed message by embedding and displaying the image data together with the free text in the recomposed message.

31. The method of claim 30, further comprising:
uploading and storing the image data and/or header at one or more central locations;
embedding a lookup reference in the recomposed message.

32. The method of claim 26, further comprising:
encrypting the recomposed message or the attached data in the message before transmission.

33. The method of claim 27, further comprising:
detecting whether the attached data is present in the recomposed message either as an embedded data or as a separate attachment.

34. The method of claim 27, further comprising:
extracting and interpreting a lookup reference embedded in the recomposed message;
downloading the attached or embedded data from the location specified by the lookup reference.

35. The method of claim 27, further comprising:
verifying authenticity of the received message by comparing data in the received message against the data uploaded by the sender at a centralized location.

36. The method of claim 27, further comprising:
extracting header from the image data of the received message in order to obtain and interpret information on encoding and/or encryption methods applied to the image data.

37. The method of claim 27, further comprising:
converting the extracted data into the formatted or serialized data;
converting the formatted or serialized data back into the structured data in the original composite data message.

38. The method of claim 27, further comprising:
inferring at least some of information lost in transmission based on other values that are part of the messages previously and/or subsequently received.

39. The method of claim 38, further comprising:
inferring a relationship between the received message and other previously and subsequently sent and received composite data messages that have been tagged as belonging to the same conversation.

40. The method of claim 38, further comprising:
inferring the structured data in the composite data message by conducting a semantic analysis on contents of the received message to infer additional information.

41. The method of claim 38, further comprising:
inferring lost data by providing a signal to the recipient indicative of the inferred data and accepting input from the recipient indicative of correction, acceptance or rejection of the inferred data.

42. A machine readable medium having software instructions stored thereon that when executed cause a system to:
detect and separate structured data from a composite data message comprising at least a free text data and the structured data;
convert the separated structured data into a data format commonly embeddable in a conventional message;
generate a recomposed message by attaching the converted data in the data format to the free text of the composite data message;
transmit the recomposed message to one or more recipients over a heterogeneous messaging environment without losing any information in the message.

43. The machine readable medium of claim 28, further having software instructions stored thereon that when executed cause a system to:
detect and extract the attached or embedded data in the recomposed message from the rest of free text of the recomposed message;
reversely convert the extracted data back into the structured data in the original composite data message;
reconstruct the original composite data message by integrating the converted structured data with the free-text data in the message.
